(19) United States
(12) Patent Application Publication
(10) Pub. No.: US 2014/0170612 A1
(43) Pub. Date: Jun. 19, 2014

(54) Computer Program Method for Teaching Languages which Includes an Algorithm for Generating Sentences and Texts

(71) Applicant: Vladimir Yudavin, Haifa (IL)

(72) Inventor: Vladimir Yudavin, Haifa (IL)

(21) Appl. No.: 14/084,648

(22) Filed: Nov. 20, 2013

(30) Foreign Application Priority Data
Dec. 13, 2012 (IL) 223617

(51) Int. Cl. G09B 19/06

(52) U.S. Cl. CPC G09B 19/06
USPC 434/157

(57) ABSTRACT

A method for computer program for studying a foreign language, which includes an algorithm that automatically generates words, word conjugations, word combination, sentences and texts in the relevant foreign language to provide the learner with a wide variety of words, word conjugations, word combinations, sentences and texts that may be used to practice the language.

### TECHNICAL FIELD

The present invention refers to a computer program method that teaches foreign languages, which includes a unique algorithm that generates words, word conjugations, word combinations, sentences, and texts designed to help students learn both specific topics and the relevant foreign language.

### BACKGROUND ART

Many computer programs currently exist that teach foreign languages using computers. Such computer programs include databases of sentences and texts designed to help the learner practice the topic of the specific lesson as well as the grammatical rules of the foreign language.

For example, GREDINA Elena and PAVLJUCHENKO Elena in their Russian patent 2153705 (C1) “English Teaching Method” describe the method includes studying grammar and translating texts using model structures based on Russian grammar. According the method, the main syntactic elements are taken out of sentence by putting questions and then mentioned elements are learned on the bases of Russian grammar at the same time noting their essential characters in English. For translating from Russian to English use is made of algorithm that involves putting questions to all articles of sentence, determining function of each word as syntactic element, ordering Russian words in appropriate sequence corresponding to order of words in English sentences, introducing missing syntactic elements, compiling scheme of English sentence using English grammar characters of syntactic elements, and putting words into translation scheme.

FAIRWEATHER John in U.S. patent application 2008228748 “Language Independent Stemming” describes using stemming algorithms together in a multilingual environment based on shortest path techniques. The goal of the stemmer is to find the shortest path to construct the entire word. The stemmer uses dynamic dictionaries constructed as lexical analyzer state transition tables to recognize the various allowable word parts for any given language in order to obtain maximum speed. The stemming framework provides the necessary logic to combine multiple stemmers in parallel and to merge their results to obtain the best behavior.

ROTHENBERG Martin in U.S. Pat. No. 6,134,529 “Speech recognition apparatus and method for learning” describes the improvement of computer speech recognition programs to reliably recognize and understand large word and phrase vocabularies for teaching written language skills. At each step of a teaching program, information is supplied to the user such that some responses in the language being taught are correct (or appropriate) and some are incorrect (or inappropriate), with these respective sets of responses judiciously selected to teach some language aspect (i.e., vocabulary, sentence structure). A subset of allowable correct; and incorrect responses is selected such that a speech recognition subprogram readily discerns certain allowable responses from other allowable responses, including each incorrect response being discriminable from each correct response. The meanings of at least the correct allowable responses are made clear by aural or visual information, such as graphic images, printed text, or translations into the user's native language.

And finally, RUSSELL Thor M. in U.S. patent application 2006004567 “Method, System and Software for Teaching Pronunciation” describes a method for teaching pronunciation using formant trajectories and for teaching pronunciation by splitting speech into phonemes. According to this method, a speech signal is received from a user, the words are detected within the signal, the voice/unvoiced segments are detected within the words. The formants of the voiced segments can be calculated, the vowel phonemes may be detected using a weighted sum of a Fourier transform measure of frequency energy and a measure based on the formants, and a formant trajectory may be calculated for the vowel phonemes using the detected formants.

The task of compiling in advanced sentences and texts requires the investment of great deal of work, time and resources, currently available computer programs that teach foreign languages usually do not include enough practice sentences and texts. The present invention provides a good and efficient solution for the aforementioned problem.

### LIST OF DRAWINGS

FIG. 1 is a first flowchart showing example of the invention.

FIG. 2 is a second flowchart showing example of the invention.

FIG. 3 is a third flowchart showing example of the invention.

### THE INVENTION

The present invention refers to a computer program method that teaches a foreign language (hereinafter “the innovative computer program”), which includes an algorithm that automatically generates words, conjugates words, and creates word combinations, sentences and texts in the relevant foreign language according to the topic of the specific lesson the user is learning, as well as on more general topics (hereinafter “the algorithm”). The innovative computer program provides the learner with a wide and diverse variety of words, conjugations, word combinations, sentences and texts that he or she can use to practice the lesson.

An algorithm that generates words, word conjugations, word combinations, sentences and texts may be based, for example, on the patent application PCT filed in France Mar. 6, 2002 by Chardenon Christine which was published as WO 2003075246 A2 “Generation of fill-in-the-blank exercises for language learning”. This method is “invention relates to the generation of fill-in-the-blank exercises for language learning. Each word from an initial text is associated with a label containing the grammatical category and at least one morpho-syntactic property of the word, in order to create annotated words. Textual models which are at least representative of one word and which contain one label of the represented word are predefined by a teacher or administrator and prestored such that they are associated with the recommendations in accordance with the substitution rules. The labels in the annotated words and the textual models are compared in order to mark the word in an annotated word when the grammatical categories are identical and the morpho-syntactic properties are compatible in the labels. The marked words are replaced by blanks followed by recommendations which are associated with the models by the rules.”

In current invention not specific words from predefined test are analyzed, but the text itself is built from word list, according to language grammar and word attributes.

As mentioned, the innovative computer program includes an algorithm that generates words, word conjugations, word combinations, sentences and texts designed to be used by the learner to practice the topic of the lesson. The computer program and the algorithm are designed so that sentences and texts are generated according to the topic of the lesson, as per the learner's choice.

The innovative computer program and algorithm may include options that enable the user to choose the general list of words the algorithm uses to generate the words, sentences and texts. This list may be either a fixed database of words or a selection of words the user chooses from a word list, so that the sentences are made up of words with whose meaning the user is familiar, and so that the activity focuses on practicing the language's grammatical rules rather than on the translation of new words. Nevertheless, the computer program and algorithm also include the option of randomly selecting words for the said words, conjugations, word combinations, sentences and texts. Needless to say, the innovative computer program and algorithm generate the words, word combinations, sentences and texts according to the grammatical rules of the relevant language.

Following is an example of a generating algorithm. We emphasize that this example is for illustration purposes only and in no way does it restrict or limit the invention or any implementation thereof.

As is known, every word has attributes and forms, each of which can, in turn, have its own attributes. For example, the Russian word for TREE is [symbol] -[dérevo], which has a gender attribute (neuter) and can be either singular ( [symbol] -[dérevo]) or plural ( [symbol] -[derév'ja]). Let's taking into account nominative case only for simplicity.

If the Russian word for TREE was selected, either randomly or according to a predefined scenario, to be the main member of a phrase, then the next step would be to choose the final word form, e.g. plural. Thus, the final form has both common and specific form attributes, which in this case are: { [symbol] , gender=neuter, person=three, number=plural}.

Now the algorithm adds an appropriate adjective, for instance the color GREEN ( [symbol] -[zeljónyj]). The Russian word for GREEN can take on one of four different forms (in nominal case):

(a) [symbol] -[zeljónyj]-male gender—singular;

(b) [symbol] -[zeljónaja] female gender—singular;

(c) [symbol] -[zeljónoje]—neuter gender—plural;

(d) [symbol] -[zeljónyje]—any gender—plural;

It is clear that if the algorithm chooses a plural version of the noun in the first step, the corresponding adjective must be also plural. Thus, in this example the color will be plural and the gender doesn't matter: { [symbol] -[zeljónyje], number=plural}. The final word combination in this case will, therefore, be [symbol] [symbol] -[zeljónyje derév'ja]=green trees.

The next step is to add a verb. Let us assume, for instance, that we wish to use the past tense and the verb RUN ( [symbol] -[be\check{z}át']—to run). True, trees rarely run, but for the sake of learning grammar it does not really matter. We already have the word TREE with attributes {gender=male, person=three, number=plural} and now we must add the attribute tense=past, to yield the final criteria {gender=male, person=three, number=plural, tense=past}. Verbs in Russain may take on several forms, and the one corresponding to male-third person-plural-past is [symbol] (be\check{z}áli). This means that, so far, the algorithm has generated the phrase: [symbol] [symbol] [symbol] -[zeljónyje derév'ja be\check{z}áli] (green tree run). We can continue this process until a full sentence is generated. Predefined tables with attributes and the required forms as well as prerecorded sound files can be used or, alternatively, such can be generated dynamically based on grammatical rules and speech synthesis software.
Let's show how we can construct the whole phrase in such way.

There is well known English phrase “The quick brown fox jumps over the lazy dog” (it's famous because it contains all English letters). Actually it is affirmative sentence with subject, object (both are compound from noun and adjective), and verb in present continuous tense. For language learning purpose we can construct various random sentences following the same pattern, and even extending it.

Step 1. Take input word lists and tenses.

nouns (singular/plural forms): “bear/bears”, “dog/dogs”, “fox/foxes”, “rabbit/rabbits”

adjectives: “quick”, “slow”, “smart”, “lazy”, “green”, “blue”

prepositions: “over”, “near”, “around”

verbs (base form/third person singular/past/past particle/present/particle):
“jump/jumps/jumped/jumped/jumping”
“go/goes/went/gone/going”
“fly/flies/flew/flown/flying”

Tenses: present indefinite, present continuous, present perfect.

Step 2. Choose subject.

Randomly pick-up noon and adjective from input list, e.g. bear/green.

Randomly choose number, e.g. singular. Combine then together to “green bear”.

Step 3. Choose object.

Randomly pick-up noon and adjective from input list, e.g. rabbit/smart.

Randomly choose number, e.g. plural. Combine then together to “smart rabbit”.

Step 4. Adding verb.

Take random verb, for example “fly”. Select tense, for instance present continuous. Take appropriate form of “fly” from the list, it's “flying”. Add “to be” in form corresponding to this present tense and number of object form step 1, that is singular. Appropriate form is “is”, final result is “is flying”.

Step 5. Preposition and final phrase.

Chose random preposition, that is “around” and put all parts in final phrase:

“The green bear is flying around the smart rabbit”.

In this example we used random number generator and list with predefines word forms, but actual implementation can use any others ways to achieve the same result (e.g. not form lists, but algorithms for specific language grammar).

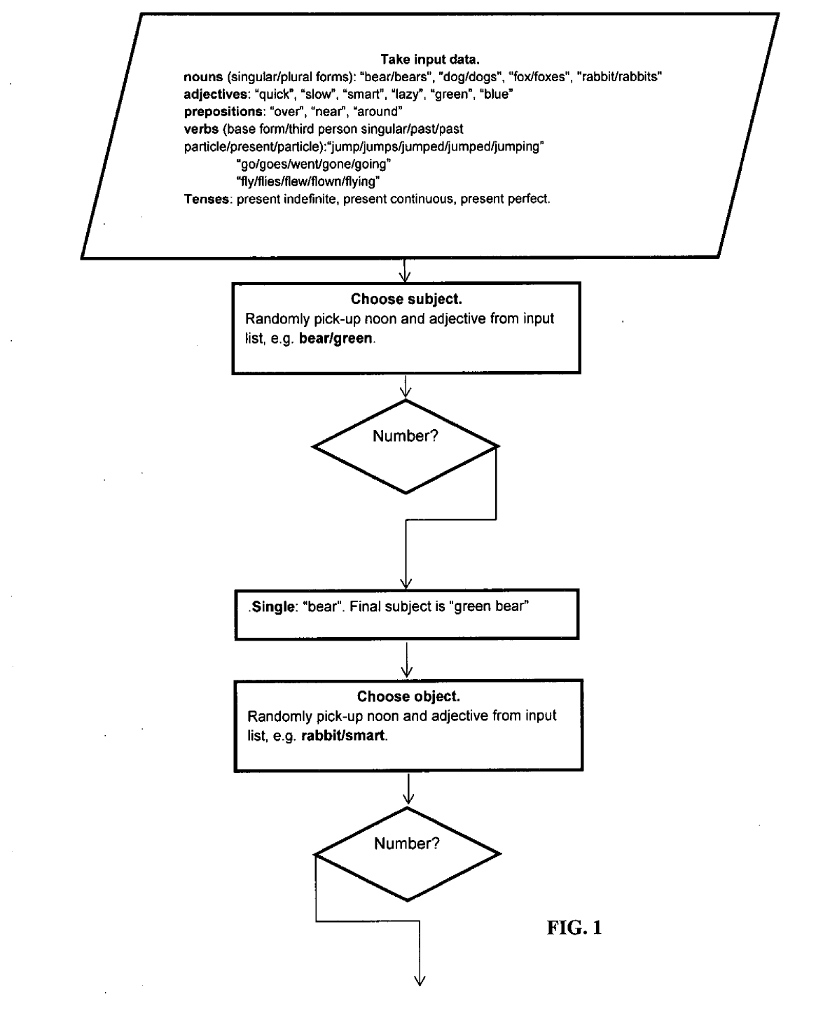

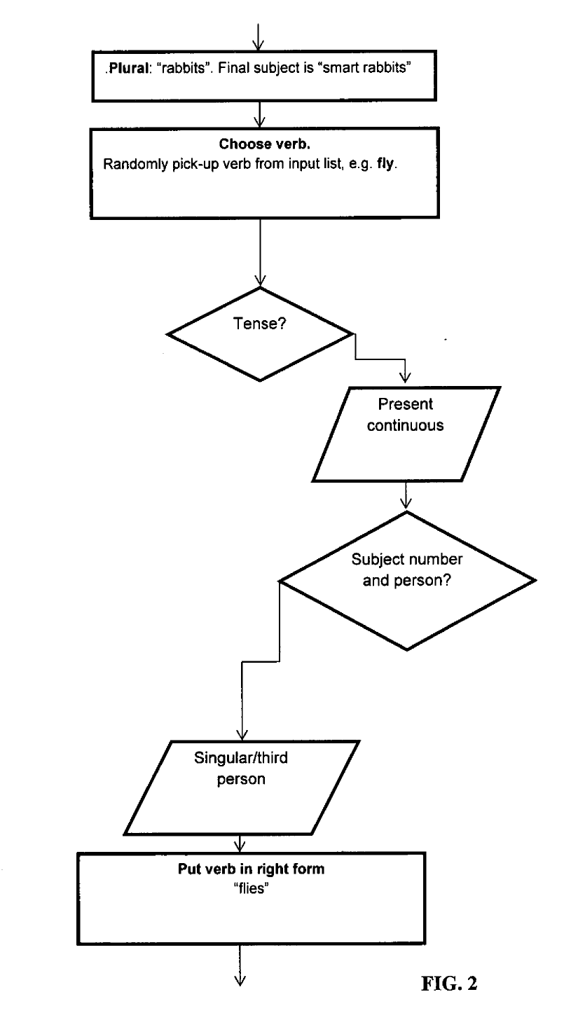

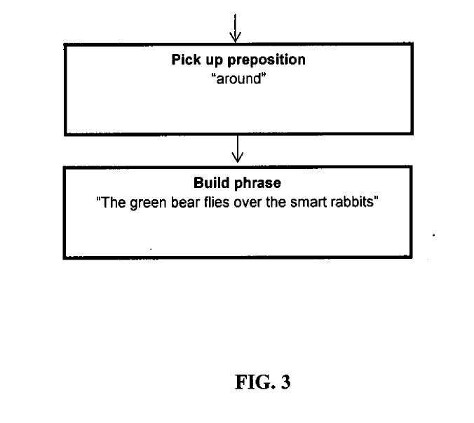

More detailed flowchart of the same example is shown on FIGS. 1-3

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are preferred by way of example to facilitate comprehension of the invention and should not be construed to limit the scope thereof.

What is claimed is:

1. A method for computer program for studying a foreign language, which includes an algorithm that automatically generates words, word conjugations, word combination, sentences and texts in the relevant foreign language to provide the learner with a wide variety of words, word conjugations, word combinations, sentences and texts that may be used to practice the language.

2. The method for computer program mentioned in claim No. 1 wherein it also includes the option of generating a wide variety of words, word conjugations, word combinations, sentences and texts according to the lesson topic and the learner's choice.

3. The method for computer program mentioned in claim No. 1 wherein it also includes the option of selecting the variety of words to be used by the algorithm to generate the said words, word conjugations, word combinations, sentences and texts.
